(19) United States
(12) Patent Application Publication
(10) Pub. No.: US 2002/0068530 A1
(43) Pub. Date: Jun. 6, 2002

(54) DEVICE AND PROCESS FOR COUPLING MULTI-BAND TRANSMITTERS AND RECEIVERS AND COMMUNICATION SYSTEM EMPLOYING SAME

(76) Inventor: LEO L. LI, TRABUCO CANYON, CA (US)

Correspondence Address: FOLEY & LARDNER, 2029 CENTURY PARK EAST, SUITE 3500, LOS ANGELES, CA, 90067-3021, US

(21) Appl. No.: 09/160,646

(22) Filed: Sep. 25, 1998

(51) Int. Cl. H04B 1/44; H04B 1/46; H04Q 7/20; H04M 11/00

(52) U.S. Cl. 455/82; 455/78; 455/83

(57) ABSTRACT

A communication system for communicating RF signals at a plurality of communication standards through a common antenna is disclosed. The communication system includes a transmitter having transmitter outputs for generating transmit band signals in the transmit bands of each supported communication standard, and a receiver having receiver inputs for receiving receive band signals in the receive bands of each supported communication standard. The communication system also includes a plurality of RF switches. Each RF switch couples either the transmitter output or the receiver input associated with a particular communication standard to the antenna. Whether the communication unit is in transmit mode or receive mode, a harmonic filter coupled between each RF switch and the common antenna filters out harmonics of the transmit band and receive band signals. Each harmonic filter has a passband substantially encompassing the transmit and receive bands of the particular communication standard associated with the coupled RF switch.

### BACKGROUND OF THE INVENTION

1. Field of the Invention

The present invention relates, generally, to communication systems, devices, and processes which use radio frequency (RF) transmitters and receivers, and, in particular embodiments, to such systems, processes, and devices which couple multi-band transmitters and receivers to a common antenna with minimal insertion loss, cost, and complexity.

2. Description of Related Art

It has become increasingly important to minimize the size, weight and power consumption of various electronic devices, especially personal communication devices such as cellular telephones, personal pagers, cordless telephones, and the like. One way to minimize such characteristics is to minimize the number of components and functions required in the electronic device. However, personal communication devices such as cellular telephones often require complex circuitry with a number of power-inefficient components for performing particular functions. This is especially true in modern cellular communications, where several different communication standards are employed worldwide, and cellular telephones with the flexibility to operate under multiple communications standards are highly desirable from a consumer and manufacturing perspective.

For example, GSM900 (Global System for Mobile 900) is a digital cellular standard operating in the 900 MHz frequency band that is currently used in Europe and Asia. DCS 1800 is another digital cellular standard based on GSM technology, operating in the 1800 MHz frequency band and also currently used in Europe and Asia. The United States uses PCS 1900, a third digital cellular standard similar to DCS 1800, but operating in the 1900 MHz band. Multi-band cellular telephones capable of operating under all of these standards afford consumers widespread applicability and allow manufacturers to benefit from the cost-efficiency of a common design.

Multi-band cellular telephones must be capable of transmitting and receiving different amplified and modulated transmit band signals through a common antenna. In addition, harmonics of the carrier frequencies must be filtered. To multiplex several different transmit band signals into a common antenna, some conventional multi-band cellular telephones use a resistor combiner, where first ends of individual resistors are coupled to the output of different transmit band generators, second ends of the individual resistors are coupled together, and another resistor is coupled between the second ends and an antenna. The resistor combiner allows simultaneous connection of multiple transmit band generators, and therefore does not require any control circuitry. However, resistor combiners may produce as much as 6 dB of loss, resulting in wasted power, and do not provide any filtering for harmonics of the carrier frequency.

Another conventional approach uses an RF switch (for example, a GaAs or pin diode switch) controlled by a band select signal. In this approach, only one transmit band generator is connected to the antenna at any time. The RF switch approach has less loss than the resistor combiner, but it requires more expensive parts and the implementation of a band select control signal system. The RF switch approach also does not provide any filtering for harmonics of the carrier frequency.

### SUMMARY OF THE DISCLOSURE

Therefore, it is an object of embodiments of the present invention to provide a device, system and method for a communication unit that simultaneously couples multi-band transmitters and receivers to a common antenna with minimal insertion loss and wasted power relative to conventional systems, devices, and methods.

It is a further object of embodiments of the present invention to provide a device, system and method for a communication unit that simultaneously couples multi-band transmitters and receivers to a common antenna and filters harmonics of the carrier frequencies.

It is a further object of embodiments of the invention to provide a system, device, and method for a communication unit that simultaneously couples multi-band transmitters and receivers to a common antenna using minimal complexity and cost relative to conventional systems, devices, and methods.

These and other objects are accomplished according to a communication system for communicating RF signals at a plurality of communication standards through a common antenna. Each communication standard has distinct transmit and receive bands. Examples of communication standards include the GSM, DCS, and PCS standards. The communication system includes a transmitter having transmitter outputs for generating transmit band signals in the transmit bands of each supported communication standard, and a receiver having receiver inputs for receiving receive band signals in the receive bands of each supported communication standard. The communication system also includes a plurality of RF switches. Each RF switch couples either the transmitter output or the receiver input associated with a particular communication standard to the antenna. Whether the communication unit is in transmit mode or receive mode, a harmonic filter coupled between each RF switch and the common antenna filters out harmonics of the transmit band and receive band signals. Each harmonic filter has a passband substantially encompassing the transmit and receive bands of the particular communication standard associated with the coupled RF switch.

These and other objects, features, and advantages of embodiments of the invention will be apparent to those skilled in the art from the following detailed description of embodiments of the invention, when read with the drawings and appended claims.

### BRIEF DESCRIPTION OF THE DRAWINGS

FIG. 1 is block diagram representation of a system environment according to an example embodiment of the present invention.

FIG. 2 is a more detailed block diagram representation of the modulator in the system of FIG. 1.

FIG. 3 is a block diagram representation of dual band communication system according to an embodiment of the present invention.

FIG. 4 is a schematic diagram of a GSM harmonic filter and a DCS/PCS harmonic filter according to an embodiment of the present invention.

FIG. 5 is a plot of the frequency response of a GSM harmonic filter and a DCS/PCS harmonic filter according to an embodiment of the present invention.

FIG. 6 is a block diagram representation of triple band communication system according to an embodiment of the present invention.

### DETAILED DESCRIPTION OF PREFERRED EMBODIMENTS

In the following description of preferred embodiments, reference is made to the accompanying drawings which form a part hereof, and in which is shown by way of illustration specific embodiments in which the invention may be practiced. It is to be understood that other embodiments may be utilized and structural changes may be made without departing from the scope of the preferred embodiments of the present invention.

Cellular communication systems employ several different communication standards worldwide. Multi-band cellular telephones with the flexibility to operate under multiple communications standards afford consumers widespread applicability and allow manufacturers to benefit from the cost-efficiency of a common design. Embodiments of the present invention relate to systems, processes, and devices which couple multi-band cellular transmitters and receivers to a common antenna with minimal insertion loss and complexity.

It should be noted that multi-band transmitters and receivers according to embodiments of the present invention are not unique to cellular communications and may be employed in a variety of communications electronics, including wireless transmission systems as well as wired systems. Thus, embodiments of the invention described herein may involve various forms of communications systems. However, for purposes of simplifying the present disclosure, preferred embodiments of the present invention are described herein in relation to personal wireless communications systems, including, but not limited to digital mobile telephones, digital cordless telephones, digital pagers, combinations thereof, and the like. Such personal communications systems typically include one or more portable or remotely located receiver and/or transmitter units.

Specifically, for purposes of illustration, the following discussion will focus on cellular communications and three communication standards, GSM900, DCS 1800, and PCS1900. In GSM900, frequency bands are allocated such that a mobile subscriber unit will transmit signals over a transmit band of between 890 and 915 MHz and will receive signals over a receive band of between 935 to 960 MHz. The transmit band is broken up into 125 channels, each channel separated by 200 kHz. In DCS1800, frequency bands are allocated such that a mobile subscriber unit will transmit signals over a transmit band of between 1710 and 1785 MHz and will receive signals over a receive band of between 1805 and 1880 MHz. The transmit band is broken up into 375 channels, each channel separated by 200 kHz. In PCS 1900, frequency bands are allocated such that a mobile subscriber unit will transmit signals over a transmit band of between 1850 and 1910 MHz and will receive signals over a receive band of between 1930 and 1990 MHz. The transmit band is broken up into 300 channels, each channel separated by 200 kHz. However, references to GSM, DCS, and PCS below are intended to refer generally to any set of different communication standards.

A generalized representation of a communication system according to an embodiment of the present invention is shown in FIG. 1, wherein a communication system 10 includes a transmitting unit 12 and a receiving unit 14, coupled for communication over a communication channel 42. The transmitting unit 12 includes a modulator 16 connected to receive a data signal (baseband signal) from a signal source 18. In one representative embodiment, the signal source 18 may include, for example, a microphone for converting sound waves into electronic signals and sampling and analog-to-digital converter electronics for sampling and converting the electronic signals into digital signals representative of the sound waves. In other embodiments, the signal source 18 may include any suitable device for producing digital data signals for communication over the channel 42, such as, but not limited to, a keyboard, a digital voice encoder, a mouse or other user input device, a sensor, monitor or testing apparatus, or the like.

The modulator 16 provides a modulated signal 32 as an output to a transmitter 20. A transmit signal 26 is produced by the transmitter 20 for transmission from an antenna 22. The receiving unit 14 includes a receiver 24 connected to an antenna 22 to process a receive signal 44. The receiver 24 provides a modulated receive signal 34 to a demodulator 28 for demodulation to produce the data signal (baseband).

The demodulated (baseband) signal output from the demodulator 28 may be provided to signal processing electronics, sound producing electronics or the like, depending upon the nature of use of the communication system. The transmitter and receiver units include further components, power supplies, and the like, well known in the art for effecting transmission and reception of signals and for carrying out other functions specific to the nature and application of use of the system.

In preferred two-way communication system embodiments, such as cellular telephone embodiments or cordless telephone embodiments, each transmitting unit 12 and receiving unit 14 is configured to function as both a transmitting unit and a receiving unit. In one system embodiment, the transmitting unit 12 and receiving unit 14 transmit and receive signals directly therebetween. In other system embodiments, the transmitting unit 12 and receiving unit 14 communicate through one or more additional transmitter/receiver configurations (such as repeater, base or cell stations), generally represented as reference character 30 in FIG. 1.

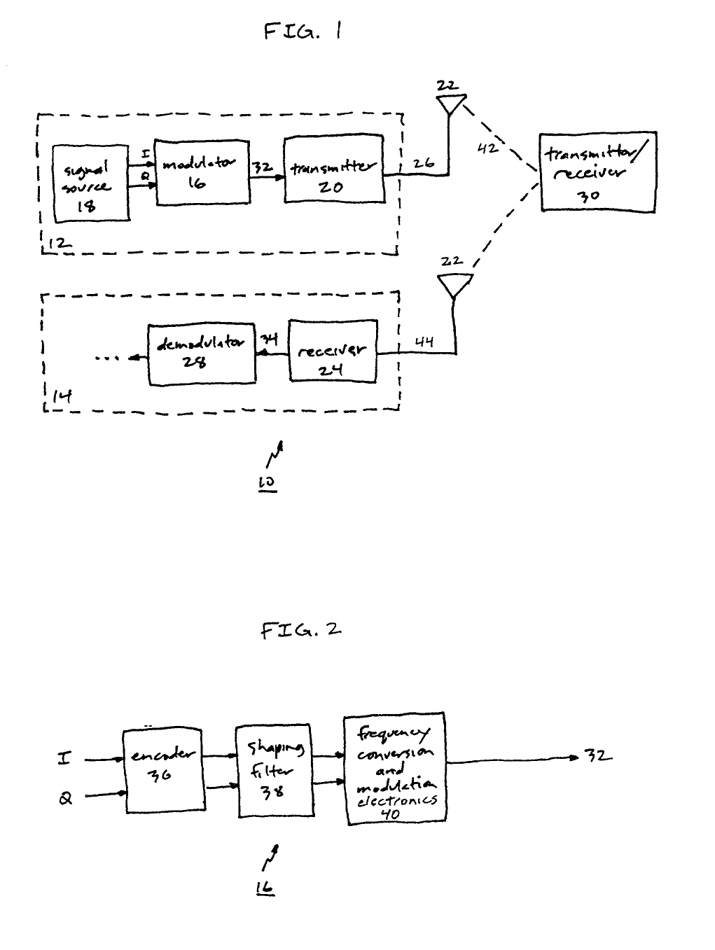

As illustrated in the modulator 16 of FIG. 2, in digital cellular telephone or cordless telephone system embodiments the signal source 18 provides sampled voice (or sound) signals in the form of baseband I and Q channel signals to an encoder 36. In one preferred cellular telephone embodiment, the encoder 36 comprises a Phase Shift Key encoder, such as, but not limited to, a π/4-shift Quadrature Phase Shift Key mapper with differential encoder (π/4 DQPSK), and shaping filter 38 comprises a pulse shaping filter for smoothing the encoder output signal. An example of a π/4 DQPSK and pulse shaping electronics is described in the article titled: “π/4-shift QPSK Digital Modulator LSIC for Personal Communication Terminals,” by Tetsu Sakata, Kazuhiko Seki, Shuji Kubota and Shuzo Kato, Proc. 5th IEEE International Symposium on Personal, Indoor and Mobile Radio Communications, 1994 (incorporated herein by reference). Other embodiments may employ other suitable encoding schemes, including but not limited to Amplitude Shift Keying and Frequency Shift Keying schemes.

I and Q outputs of the encoder pass through shaping filter 38 and then to the frequency conversion and modulation electronics 40, the output of which comprises a modulated signal 32. Modulated signal 32 is then fed to transmitter 20 as shown in FIG. 1, which provides the transmit signal 26 to the antenna 22 for transmission.

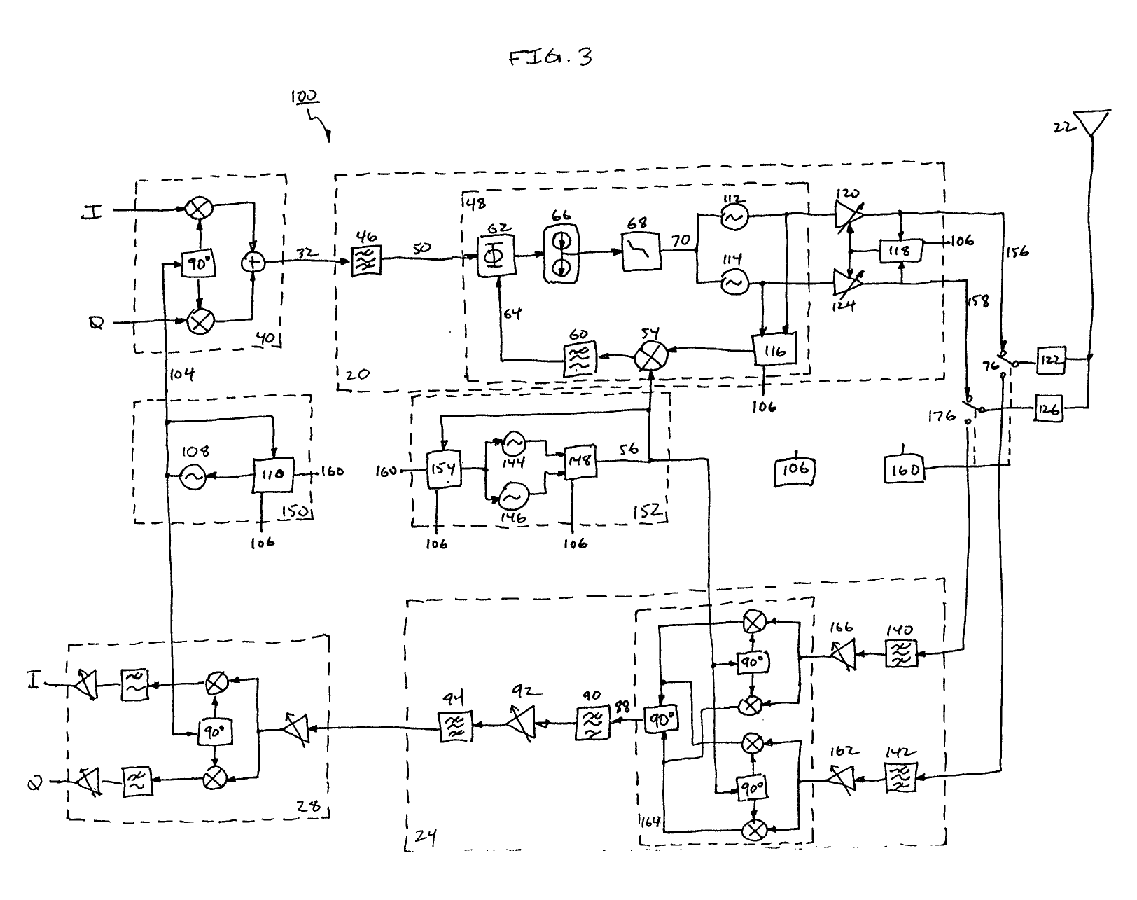

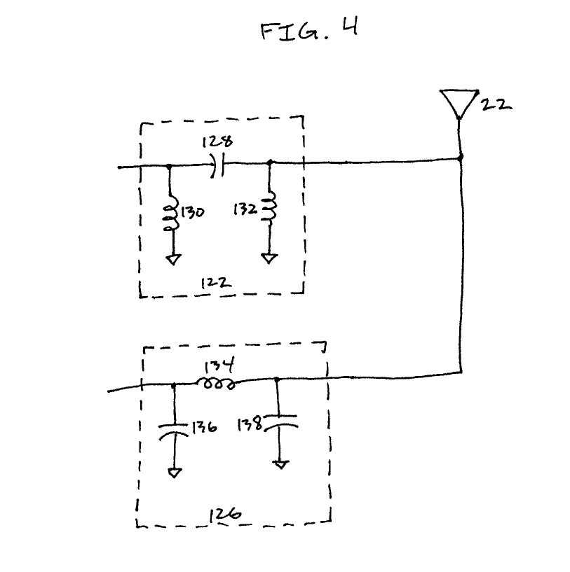

A dual-band communication system 100 according to an embodiment of the present invention is illustrated in FIG. 3. For purposes of illustration and discussion, the dual-band communication system 100 of FIG. 3 is switchable between the GSM900 and DCS1800 communication standards. However, references to GSM and DCS are intended to refer generally to any two communication standards.

Frequency conversion and modulation electronics 40 receive the I and Q outputs of the shaping filter 38 (see FIG. 2) and modulate an auxiliary synthesizer frequency 104 with the I and Q outputs to produce a modulated signal 32. In preferred embodiments, auxiliary synthesizer frequency 104 is generated by an auxiliary frequency generator 150 containing an IF frequency generator 108 and auxiliary loop electronics 110 phase-locked to a reference source (not shown in FIG. 3). However, in alternative embodiments of the present invention, auxiliary frequency generator 150 may be any adjustable frequency source.

A first filter 46 having a bandwidth sufficient to pass the modulated signal 32 with minimal distortion filters the modulated signal 32 before it enters an upconverter 48. In preferred embodiments of the present invention, upconverter 48 includes two paralleled frequency generators, a GSM frequency generator 112 for generating GSM carrier frequencies and a DCS frequency generator 114 for generating DCS carrier frequencies. The outputs of GSM frequency generator 112 and DCS frequency generator 114 are selectively couplable to mixer 54 through an upconverter switch 116, and are phase-locked to a main synthesizer frequency 56. In preferred embodiments of the present invention, GSM frequency generator 112 and DCS frequency generator 114 are VCOs. In alternative embodiments of the present invention, upconverter switch 116 may be an RF switch, a resistor combiner, or a diplexer (two filters coupled together at their outputs).

In preferred embodiments, mixer 54 generates the difference between the frequency at the output of upconverter switch 116 and main synthesizer frequency 56 generated by main frequency generator 152. Main frequency generator 152 includes two paralleled frequency generators and main loop electronics 154 phase-locked to a reference source (not shown in FIG. 3). The two paralleled frequency generators include a main GSM frequency generator 144 for producing frequencies sufficient to generate desired GSM transmit or receive band frequencies, and a main DCS frequency generator 146 for producing frequencies sufficient to generate desired DCS transmit or receive band frequencies. The outputs of main GSM frequency generator 144 and main DCS frequency generator 146 are selectively couplable to mixer 54 and main loop electronics 154 through a main frequency generator switch 148. In preferred embodiments of the present invention, main GSM frequency generator 144 and main DCS frequency generator 146 may be VCOs. In alternative embodiments of the present invention, main frequency generator switch 148 may be an RF switch, a resistor combiner, or a diplexer (two filters coupled together at their outputs). In other alternative embodiments, main frequency generator 152 may be any adjustable frequency source.

Upconverter 48 further includes a feedback filter 60 for filtering the output of mixer 54, a phase detector 62 for determining the phase difference between a filtered mixer output 64 and first filter output 50, a charge pump 66 for sourcing or sinking current as determined by the phase difference output of phase detector 62, and a loop filter 68 for integrating current pulses from charge pump 66 and providing a control voltage 70 to GSM frequency generator 112 and DCS frequency generator 114. In other alternative embodiments, upconverter 48 may comprise a mixer for mixing first filter output 50 with main synthesizer frequency 56.

A GSM power amplifier 120 controllable by a power amplifier controller 118 is coupled between GSM frequency generator 112 and a GSM T/R switch 76 to generate a GSM transmit signal 156. Similarly, a DCS power amplifier 124 controllable by power amplifier controller 118 is coupled between DCS frequency generator 114 and a DCS T/R switch 176 to generate a DCS transmit signal 158. Power amplifier controller 118 receives baseband control signals (not shown in FIG. 3), senses the output power of GSM power amplifier 120 and DCS power amplifier 124, and adjusts the amplification of GSM power amplifier 120 and DCS power amplifier 124 based on these inputs and a predetermined ramping profile. A GSM harmonic filter 122 is coupled between GSM T/R switch 76 and antenna 22 to pass GSM transmit band frequencies and suppress harmonics of GSM transmit signal 156 generated by GSM power amplifier 120. A DCS harmonic filter 126 is coupled between DCS T/R switch 176 and antenna 22 to pass DCS transmit band frequencies and suppress harmonics of DCS transmit signal 158 generated by DCS power amplifier 124. Thus, GSM harmonic filter 122 and DCS harmonic filter 126 are simultaneously coupled to antenna 22.

Upconverter switch 116, main frequency generator switch 148, main loop electronics 154, auxiliary loop electronics 110, and power amplifier controller 118 are all coupled to and controllable by band selector 106. When band selector 106 is configured for GSM operation, upconverter switch 116 selects GSM frequency generator 112, main frequency generator switch 148 selects main GSM frequency generator 144, and power amplifier controller 118 enables GSM power amplifier 120 and disables DCS power amplifier 124. When band selector 106 is configured for DCS operation, upconverter switch 116 selects DCS frequency generator 114, main frequency generator switch 148 selects main DCS frequency generator 146, and power amplifier controller 118 enables DCS power amplifier 124 and disables GSM power amplifier 120.

Auxiliary loop electronics 110 and main loop electronics 154 are also controllable by transmit/receive selector circuit 160. When band selector 106 is configured for GSM operation and transmit/receive selector circuit 160 is configured for transmit operation, auxiliary loop electronics 110 configures its dividers and frequency source (not shown in FIG. 3) in accordance with a designated GSM transmit IF, and main loop electronics 154 configures its dividers and frequency source (not shown in FIG. 3) in accordance with a designated GSM transmit band. When band selector 106 is configured for GSM operation and transmit/receive selector circuit 160 is configured for receive operation, auxiliary loop electronics 110 configures its dividers and frequency source in accordance with a designated GSM receive IF, and main loop electronics 154 configures its dividers and frequency source in accordance with a designated GSM receive band. When band selector 106 is configured for DCS operation and transmit/receive selector circuit 160 is configured for transmit operation, auxiliary loop electronics 110 configures its dividers and frequency source in accordance with a designated DCS transmit IF, and main loop electronics 154 configures its dividers and frequency source in accordance with a designated DCS transmit band. When band selector 106 is configured for DCS operation and transmit/receive selector circuit 160 is configured for receive operation, auxiliary loop electronics 110 configures its dividers and frequency source in accordance with a designated DCS receive IF, and main loop electronics 154 configures its dividers and frequency source in accordance with a designated DCS receive band.

When GSM T/R switch 76 and DCS T/R switch 176 are switched to receiver 24 for operating communication system 10 in receive mode, GSM harmonic filter 122 passes GSM receive band frequencies to GSM receive filter 142, and DCS harmonic filter 126 passes DCS receive band frequencies to DCS receive filter 140. If band selector 106 is configured for GSM operation, an adjustable gain DCS downconverter amplifier 166 is disabled, while an adjustable gain GSM downconverter amplifier 162 senses the power level of received baseband signals and amplifies the output of GSM receive filter 142 accordingly. If band selector 106 is configured for DCS operation, the adjustable gain GSM downconverter amplifier 162 is disabled, while the adjustable gain DCS downconverter amplifier 166 senses the power level of received baseband signals and amplifies the output of DCS receive filter 140 accordingly. The amplified signal is then translated into a downconverted receive signal 88 by a downconverter 164 utilizing a main synthesizer frequency 56 from main frequency generator 152.

Downconverted receive signal 88 is then filtered by a first downconverted receive filter 90 to remove spurious frequencies generated by downconverter 164, amplified by an adjustable first downconverter amplifier 92 which senses the power level of received baseband signals and amplifies the output of downconverter receive filter 90 accordingly, and filtered again by a second downconverted receive filter 94 to reject noise generated by the first downconverter amplifier 92. The filtered signal then enters demodulator 28, where the signal is demodulated into baseband I and Q channel signals using an auxiliary synthesizer frequency 104 from auxiliary frequency generator 150.

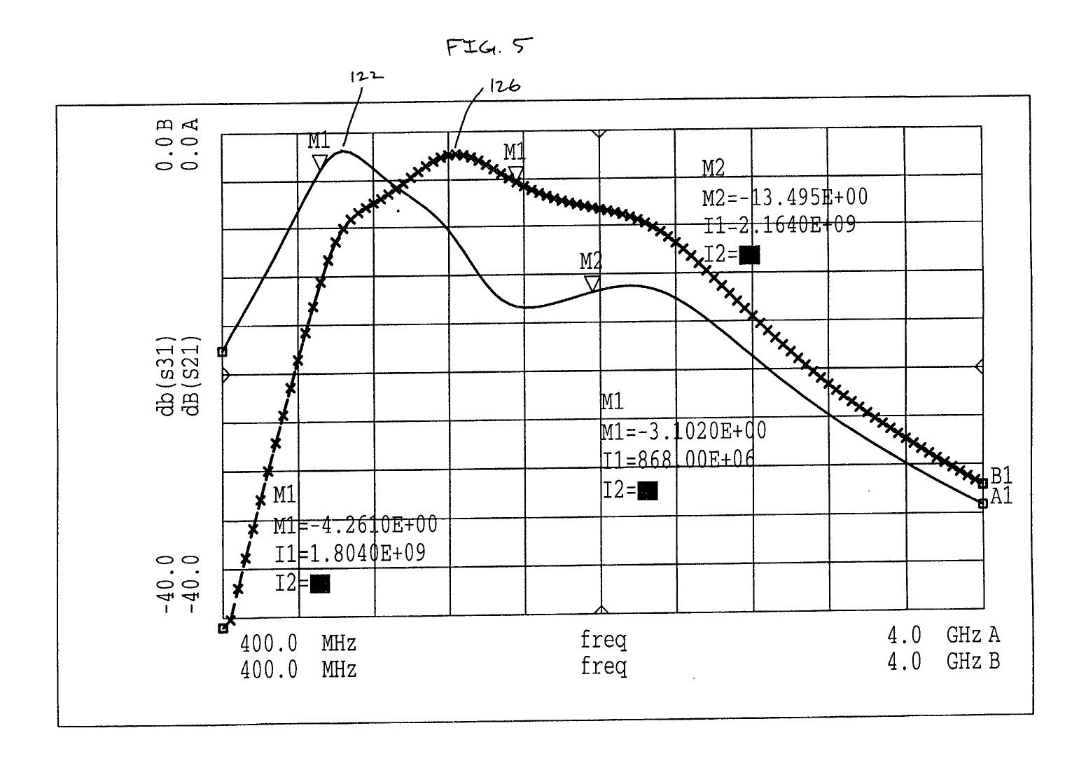

FIG. 4 is a circuit representation of GSM harmonic filter 122 and DCS harmonic filter 126 according to an embodiment of the present invention. GSM harmonic filter 122 uses low-pass filter (LPF) topology comprised of a LPF capacitor 128 coupled between a first LPF inductor 130 and a second LPF inductor 132, both inductors also connected to ground. DCS harmonic filter 126 uses high-pass filter (HPF) topology comprised of a HPF inductor 134 coupled between a first HPF capacitor 136 and a second HPF capacitor 138, both capacitors also connected to ground. It should be noted that the embodiment of FIG. 4 utilizes inexpensive components and produces very little insertion loss.

In embodiments of the present invention for the dual-band communication system 100 under discussion, component values should be chosen such that the GSM harmonic filter 122 passes frequencies in the GSM transmit band (890-915 MHz) and GSM receive band (935-960 MHz) but rejects harmonics of the GSM carrier frequency. Component values should also be chosen such that the DCS harmonic filter 126 passes frequencies in the DCS transmit band (1710-1785 MHz) and DCS receive band (1805-1880 MHz) but rejects harmonics of the DCS carrier frequency.

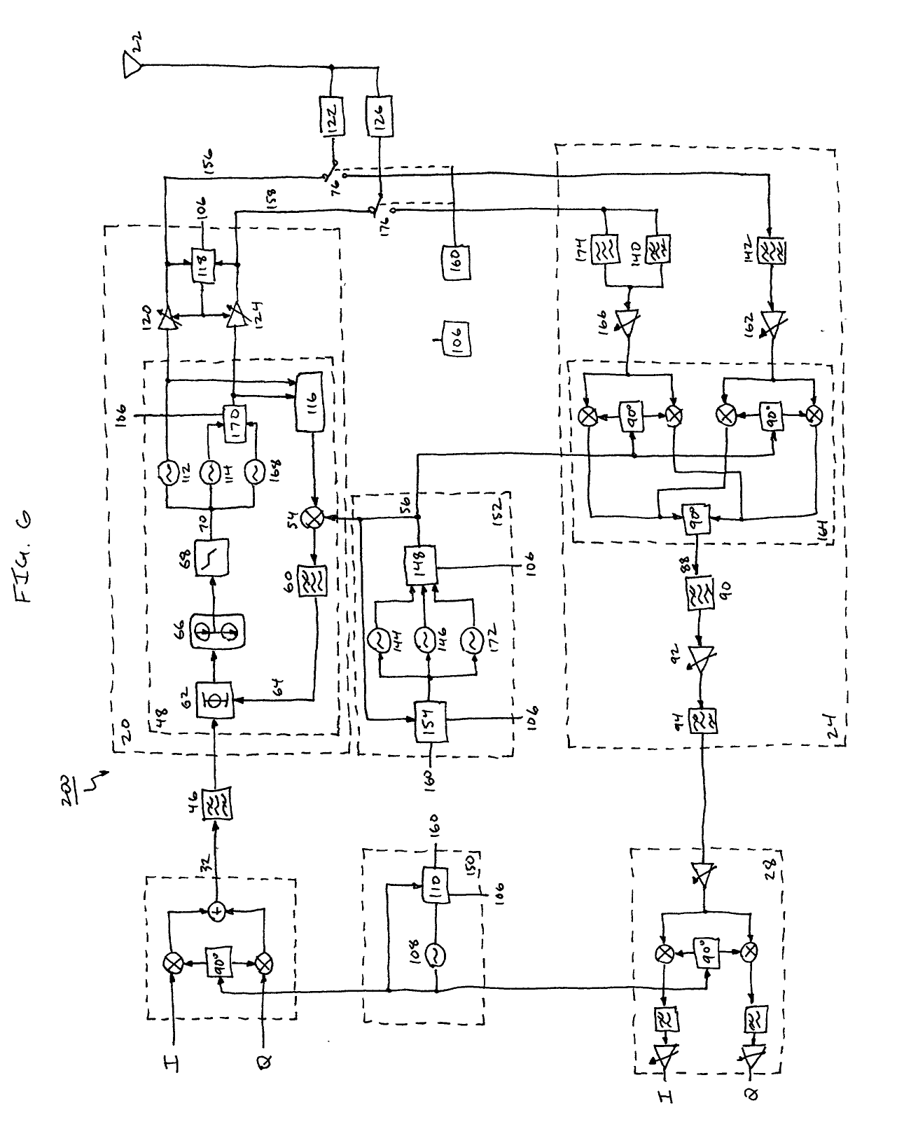

Although GSM harmonic filter 122 and DCS harmonic filter 126 utilize LPF and HPF topologies, respectively, when coupled together as in FIG. 4 the filters are mutually affected and exhibit bandpass characteristics. Thus, the design of the two filters must be conducted simultaneously. In preferred embodiments of the present invention for the dual-band communication system 100 under discussion, selecting the LPF capacitor 128 to be approximately 6.2 pF, the first LPF inductor 130 to be approximately 1.4 nH, the second LPF inductor 132 to be approximately 1.0 nH, the HPF inductor 134 to be approximately 2.6 nH, the first HPF capacitor 136 to be approximately 4.6 pF, and the second HPF capacitor 138 to be approximately 12.0 pF will result in the frequency response of FIG. 5. Reference character 122 corresponds to the frequency response of GSM harmonic filter 122, and reference character 126 corresponds to the frequency response of DCS harmonic filter 126. Frequency response 122 in FIG. 5 corresponds to a filter which passes GSM transmit and receive frequencies, while frequency response 126 corresponds to a filter which passes DCS and PCS transmit and receive frequencies.

A triple-band communication system 200 according to a preferred embodiment of the present invention is illustrated in FIG. 6. For purposes of illustration and discussion, triple-band communication system 200 of FIG. 6 is switchable between the GSM900, DCS1800, and PCS1900 communication standards. However, references to GSM, DCS, and PCS are intended to refer generally to any three communication standards. In alternative embodiments, triple band communication system 200 may be expanded to include any number of different bands.

The structure and operation of triple-band communication system 200 is similar to that of dual-band communication system 100 of FIG. 3, except for those differences noted below. In the triple-band communication system 200 of FIG. 6, upconverter 48 includes a third paralleled frequency generator, a PCS frequency generator 168 for generating PCS carrier frequencies. The outputs of PCS frequency generator 168 and DCS frequency generator 114 are selectively couplable to DCS power amplifier 124 through a DCS/PCS switch 170, controllable by band selector 106. Main frequency generator 152 includes a third paralleled frequency generator, a tunable main PCS frequency generator 172 for generating PCS transmit or receive band frequencies. The output of main PCS frequency generator 172 is selectively couplable to mixer 54 and main loop electronics 154 though main frequency generator switch 148.

Because the frequency response of DCS harmonic filter 126 passes both DCS and PCS transmit and receive frequencies, in preferred embodiments of the present invention DCS harmonic filter 126 can be used to transmit and receive both DCS and PCS channels, as illustrated in FIG. 6. Thus, DCS harmonic filter 126 passes PCS receive band frequencies as well as DCS receive band frequencies to DCS receive filter 140 and a PCS receive filter 174. The outputs of DCS receive filter 140 and PCS receive filter 174 are coupled together, as shown in FIG. 6. Because triple-band communication system 200 will receive either DCS or PCS receive band frequencies at any time, but not both, the coupled outputs of DCS receive filter 140 and PCS receive filter 174 present no mixing problem.

Therefore, according to the foregoing description, preferred embodiments of the present invention provide a device, system and method for a communication unit that simultaneously couples multi-band transmitters and receivers to a common antenna with minimal insertion loss and wasted power, and filters harmonics of transmit band carrier frequencies using minimal complexity and cost.

The foregoing description of preferred embodiments of the invention has been presented for the purposes of illustration and description. It is not intended to be exhaustive or to limit the invention to the precise form disclosed. It is intended that the scope of the invention be limited not by this detailed description, but rather by the claims appended hereto.

What is claimed is:

1. A communication device for communicating RF signals at any one of a plurality of communication standards through a common antenna, each communication standard having distinct transmit and receive bands, the communication device comprising:
a plurality of harmonic filters for filtering out harmonics of transmit band signals, each harmonic filter having a first terminal for receiving a transmit band signal in the transmit band of a particular communication standard, a second terminal, and a passband substantially encompassing the transmit band of the particular communication standard; and
at least one electrical conductor simultaneously coupling the second terminal of each harmonic filter to the antenna for communicating a filtered transmit band signal to the antenna.

2. A communication device as recited in claim 1, wherein each harmonic filter also filters receive band signals entering the second terminal from the antenna, each harmonic filter having a passband which substantially encompasses both the transmit band and receive band of the particular communication standard.

3. A communication device as recited in claim 1, the plurality of harmonic filters comprising:
an LP filter having a first LP filter terminal and a second LP filter terminal and low pass filter topology for filtering the transmit and receive band signals of a first communication standard; and
an HP filter having a first HP filter terminal and a second HP filter terminal and high pass filter topology for filtering the transmit and receive band signals of a second communication standard;
wherein the transmit and receive band signals of the first communication standard are at a lower frequency than the transmit and receive band signals of the second communication standard.

4. A communication device as recited in claim 3, wherein the HP filter further includes high pass filter topology for filtering the transmit and receive band signals of a third communication standard.

5. A communication device as recited in claim 3, the LP filter comprising:
a first LPF inductor having a first end coupled to the first LP filter terminal and a second end coupled to ground;
an LPF capacitor having a first end coupled to the first end of the first LPF inductor and a second end coupled to the second LP filter terminal; and
a second LPF inductor having a first end coupled to the second end of the LPF capacitor and a second end coupled to ground.

6. A communication device as recited in claim 3, the HP filter comprising:
a first HPF capacitor having a first end coupled to the first HP filter terminal and a second end coupled to ground;
a HPF inductor having a first end coupled to the first end of the first HPF capacitor and a second end coupled to the second HP filter terminal; and
a second HPF capacitor having a first end coupled to the second end of the HPF inductor and a second end coupled to ground.

7. A communication device as recited in claim 3, wherein the first communication standard is GSM.

8. A communication device as recited in claim 3, wherein the second communication standard is DCS.

9. A communication device as recited in claim 4, wherein the third communication standard is PCS.

10. A communication device as recited in claim 5, wherein the first LPF inductor is approximately 1.4 nH, the LPF capacitor is approximately 6.2 pF, and the second LPF inductor is approximately 1.0 nH.

11. A communication device as recited in claim 5, wherein the first HPF capacitor is approximately 4.6 pF, the HPF inductor is approximately 2.6 nH, and the second HPF capacitor is approximately 12.0 pF.

12. A communication system for communicating RF signals at a plurality of communication standards through a common antenna, each communication standard having distinct transmit and receive bands, the communication system comprising:
a transmitter having a plurality of transmitter outputs for generating transmit band signals in the transmit bands of the plurality of communication standards;
a receiver having a plurality of receiver inputs for receiving receive band signals in the receive bands of the plurality of communication standards;
a plurality of RF switches, each RF switch having a first terminal coupled to the transmitter output corresponding to a particular communication standard, a second terminal coupled to the receiver input corresponding to the particular communication standard, and a common terminal for selectively coupling the transmitter output and the receiver output of the particular communication standard to the antenna; and
a plurality of harmonic filters for filtering out harmonics of the transmit band and receive band signals, each harmonic filter having a first terminal coupled to the common terminal of an RF switch, a second terminal coupled to the antenna, and a passband substantially encompassing the transmit and receive bands of the particular communication standard associated with the RF switch.

13. A communication system as recited in claim 12, the plurality of harmonic filters comprising:
an LP filter having a first LP filter terminal and a second LP filter terminal and low pass filter topology for filtering the transmit and receive band signals of a first communication standard; and
an HP filter having a first HP filter terminal and a second HP filter terminal and high pass filter topology for filtering the transmit and receive band signals of a second communication standard;
wherein the transmit and receive band signals of the first communication standard are at a lower frequency than the transmit and receive band signals of the second communication standard.

14. A communication system as recited in claim 13, wherein the HP filter further includes high pass filter topology for filtering the transmit and receive band signals of a third communication standard.

15. A communication system as recited in claim 13, the LP filter comprising:
a first LPF inductor having a first end coupled to the first LP filter terminal and a second end coupled to ground;
an LPF capacitor having a first end coupled to the first end of the first LPF inductor and a second end coupled to the second LP filter terminal; and
a second LPF inductor having a first end coupled to the second end of the LPF capacitor and a second end coupled to ground.

16. A communication device as recited in claim 13, the HP filter comprising:
a first HPF capacitor having a first end coupled to the first HP filter terminal and a second end coupled to ground;
a HPF inductor having a first end coupled to the first end of the first HPF capacitor and a second end coupled to the second HP filter terminal; and
a second HPF capacitor having a first end coupled to the second end of the HPF inductor and a second end coupled to ground.

17. A communication device as recited in claim 13, wherein the first communication standard is GSM.

18. A communication device as recited in claim 13, wherein the second communication standard is DCS.

19. A communication device as recited in claim 14, wherein the third communication standard is PCS.

20. A communication device as recited in claim 15, wherein the first LPF inductor is approximately 1.4 nH, the LPF capacitor is approximately 6.2 pF, and the second LPF inductor is approximately 1.0 nH.

21. A communication device as recited in claim 15, wherein the first HPF capacitor is approximately 4.6 pF, the HPF inductor is approximately 2.6 nH, and the second HPF capacitor is approximately 12.0 pF.

22. A process for communicating RF signals at a plurality of communication standards through a common antenna, each communication standard having distinct transmit and receive bands, the process comprising:
generating transmit band signals in the transmit bands of the plurality of communication standards;
receiving receive band signals in the receive bands of the plurality of communication standards;
selecting either the transmit or receive band signal of a particular communication standard for communication through the antenna; and
filtering out harmonics of the transmit and receive band signals by passing only those frequencies substantially encompassing the transmit and receive bands of the particular communication standard.

23. A communication system for communicating RF signals at a plurality of communication standards through a common antenna, each communication standard having distinct transmit and receive bands, the communication system comprising:
a transmitter having a plurality of transmitter outputs for generating transmit band signals in the transmit bands of the plurality of communication standards;
a receiver having a plurality of receiver inputs for receiving receive band signals in the receive bands of the plurality of communication standards; and
means for selecting either the transmit or receive band signal of a particular communication standard for communication through the antenna, and filtering out harmonics of the transmit and receive band signals by passing only those frequencies substantially encompassing the transmit and receive bands of the particular communication standard.
